(19) United States
(12) Patent Application Publication
(10) Pub. No.: US 2026/0279208 A1
(43) Pub. Date: Sep. 17, 2026

(54) SYSTEM AND METHOD FOR DRONE ROUTES GENERATION FOR SEISMIC NODES DEPLOYMENT

(71) Applicant: SERCEL, Carquefou (FR)

(72) Inventor: Ludovic KERSAUZE, Carquefou (FR)

(21) Appl. No.: 19/079,591

(22) Filed: Mar. 14, 2025

(51) Int. Cl. G08G 5/57; G01V 1/16

(52) U.S. Cl. CPC G08G 5/57; G01V 1/168

(57) ABSTRACT

A method for generating a route for a drone for seismic node deployment includes receiving drone data, receiving field data with regard to one or more drone features, receiving a receiver processing support (RPS) file that conforms with a shell processing support format for 3D surveys as defined by society of exploration geophysicists (SEG), generating a comma-values separated (CVS) file including waypoints making up the route of the drone, based on the RPS file, the drone data, and the field data, and transmitting the CVS file to the drone for the seismic node deployment.

### BACKGROUND

### Technical Field

Embodiments of the subject matter disclosed herein generally relate to a system and method for generating a flying plan (routes) for one or more drones for deploying seismic sensors, and more particularly, to automating the generation of the drones’ routes over a given seismic survey area based on a standardized seismic survey file.

### Discussion of the Background

Land or sea seismic data acquisition and processing generate a profile (image) of a geophysical structure under the earth’s surface, which is known as the subsurface. While this profile does not provide an accurate location of oil and gas reservoirs, it suggests, to those trained in the field, the presence or absence of these reservoirs; Alternatively, other information relating to the composition of the subsurface may suggest the presence of features adequate for carbon capturing, or other material of interest. Thus, providing a high-resolution image of geophysical structures in the subsurface is an ongoing process.

Reflection seismology is a method of geophysical exploration to determine the properties of earth’s subsurface. Land or sea reflection seismology is based on using a controlled source of energy that sends the energy into the earth. By measuring the time it takes for the reflections to come back to plural receivers, it is possible to evaluate the depth of features (e.g., faults) causing such reflections. These features may be associated with subterranean hydrocarbon deposits or other layers of interest.

A seismic acquisition system for recording the reflections of the seismic waves, off the geological structures present in the subsurface, makes use of seismic nodes (e.g., geophones, accelerometers, hydrophones, electromagnetic sensor, gravity sensors, etc.). The seismic nodes are capable of providing good data because of their wide-azimuth geometry. Wide-azimuth coverage is helpful for imaging beneath complex overburdens such as those associated with salt bodies. In addition, the seismic nodes can provide multi-component data, i.e., particle motion related data along one, two, or three different directions. In one application, a seismic node can also record pressure data, in addition to the particle motion data. However, the pressure data is a one-dimensional data while the particle motion data can be three-dimensional.

An example of a seismic acquisition system that uses autonomous land nodes is shown in FIG. 1. Such a system is manufactured by the assignee of this application, and is disclosed, for example, in U.S. Patent no. 8,547,796, the entire content of which is incorporated herein by reference. The system 100 includes plural remote acquisition units (RAU) 110 (also called seismic nodes in this document) that are distributed over a land area 102 of interest. Each RAU 110 is configured to indirectly communicate with a general controller 126, which may be located in the area of interest 102. For transmitting the information from the general controller 126 to the RAU units 110 or vice versa, an ad hoc wireless network may be employed, or an aircraft (e.g., drone) 124 is flown over the RAU units for directly communicating with them, or a mobile unit 125 is moved on land, along the RAUs 110 to directly communicate with them. The aircraft 124 or mobile unit 125, called herein a harvester, may be any device that is capable of moving across the area of interest 102 for interacting with the RAU units. The harvester 124/125 then travels to the general controller 126 for exchanging information and refueling (e.g., recharging its battery if the harvester has an electrical propulsion system).

The RAU units 110 are self-powered by an internal power source, such as a battery 120 shown in FIG. 2. Each RAU includes a transceiver 122 that is configured to communicate in a wireless manner with the harvester 124/125. The RAU 110 further includes an analog-to-digital (AD) converter 114 and a memory 116 for storing the recorded seismic information. The AD converter 114 can be configured to perform a high-precision conversion of the analog signal received from one or more analog sensors 112, for example, geophones (other sensors are also possible, for example, an accelerometer). Note that the sensors 112 are located in this figure outside a housing 111 of the RAU 110. The memory 116 can be any type of memory. The RAU 110 also includes a time reference module 118, which may be implemented as a global positioning system (GPS) receiver capable of deriving an accurate time reference from GPS signals. Further, the RAU 110 may include a processing device 123 (e.g., a processor) that coordinates the above elements. After the RAU 110 captures and stores the seismic data from the sensors 112, the harvester 124/125 may pass by to collect such data after which the data collected from all the RAU units is transferred to the general controller 126.

Typically, thousands if not tens of thousands of RAU units 110 need to be deployed for a seismic survey over a given area. This action is not only time consuming, but it is also very resource intensive as somebody needs to go to each planned location of the RAU to physically deploy the RAU. Further, there are situations when the terrain is very steep, and/or exposed to elements, which makes the deployment stage dangerous for the persons that perform this task.

Thus, various groups have developed methods for deploying the seismic nodes using drones, which are fast and can quickly reach inaccessible or unhospitable desired locations for the seismic nodes. For example, the authors in [1-3] disclose the use of drones for distributing seismic sensors over a given land area. The authors in [4-5] disclose the use of drones for data harvesting while the authors in [6] disclose the use of drones as seismic nodes. Non-seismic drone usage is discussed in [7], where the authors have proposed using the drones for forestry management. In another non-seismic drone usage, the authors in [8] proposed the use of drones for package delivery. While all these documents propose the use of drones in various fields, no one discloses how to generate the flight path (routes) for the drones, which is a major bottleneck when the number of drones increases.

Thus, there is a need for a system and method that, preferably, automatically or semi-automatically generates the flight path for the drones used during a seismic survey.

### BRIEF SUMMARY OF THE INVENTION

According to an embodiment, there is a method for generating a route for a drone for seismic node deployment. The method includes receiving drone data, receiving field data with regard to one or more drone features, receiving a receiver processing support (RPS) file that conforms with a shell processing support format for 3D surveys as defined by society of exploration geophysicists (SEG), generating a comma-values separated (CVS) file including waypoints making up the route of the drone, based on the RPS file, the drone data, and the field data, and transmitting the CVS file to the drone for the seismic node deployment.

In another embodiment, there is a computing device for generating a route for a drone for seismic node deployment. The computing device includes an interface configured to receive drone data, receive field data with regard to one or more drone features, and receive a receiver processing support (RPS) file that conforms with a shell processing support format for 3D surveys as defined by society of exploration geophysicists (SEG). The computing device further includes a processor connected to the interface and configured to generate a comma-values separated (CVS) file including waypoints making up the route of the drone, based on the RPS file, the drone data, and the field data, and transmit the CVS file to the drone for the seismic node deployment.

### BRIEF DESCRIPTION OF THE DRAWINGS

For a more complete understanding of the present invention, reference is now made to the following descriptions taken in conjunction with the accompanying drawings, in which:

FIG. 1 is a schematic illustration of a traditional seismic acquisition system that includes plural seismic nodes;

FIG. 2 is a schematic illustration of a traditional seismic node;

FIG. 3 schematically illustrates a drone configured to deploy a seismic node;

FIG. 4 schematically illustrates a drone configured to deploy multiple seismic nodes;

FIGS. 5A to 5D schematically illustrates a receiver processing support file that conforms with a shell processing support format for 3D surveys as defined by the Society of Exploration Geophysicists;

FIG. 6 schematically illustrates the various inputs and steps performed by a platform for generating routes for multiple drones for deploying multiple seismic nodes for a seismic acquisition campaign;

FIG. 7 is a flow chart of a method for generating a comma-value separated file for one or more drones for deploying the seismic nodes of the seismic acquisition campaign;

FIG. 8 schematically illustrates a height of a drone when following the calculated route for deploying plural seismic nodes;

FIG. 9 schematically illustrates possible divisions of a land seismic survey area with each division being covered by a corresponding drone;

FIG. 10 schematically illustrates underwater drones used for deploying underwater seismic nodes for seismic acquisition; and

FIG. 11 schematically illustrates a computing system that implements the methods discussed in this document.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a seismic survey acquisition campaign employes thousands of seismic nodes and one or more seismic sources. These assets are planned to be distributed over a given land area, according to specific requirements. For example, the coordinates of each receiver group (a receiver group may include plural seismic nodes) is specified in a master plan document, the shot points of each source hen shooting are also specified in the master plan document. The master plan document is standardized so that the seismic survey companies over the world use the same format. A computing device is configured to read the master plan document, extract the planned locations of the seismic nodes, and, based on knowledge about the number of drones to be used for deployment, and one or more characteristics of the drones, to automatically calculate the route or trajectory (waypoints) for each drone for deploying the thousands of seismic nodes. The mechanism for generating the waypoints for the available drones is now discussed.

The seismic acquisition campaigns are performed by various specialized companies as a service for exploitation companies, in particular the oil and gas companies (those companies that drill and extract the resources from the earth). As discussed above, a seismic acquisition campaign involves the deployment of many seismic nodes, the recording of the seismic data with the deployed seismic nodes, the maintenance of the seismic nodes as the seismic acquisition campaign is ongoing (it can takes days or weeks to finalize the acquisition), and then the retrieval of the seismic nodes. Then, the collected seismic data is analyzed and an image of the surveyed surface is generated so that the oil and gas companies can determine where to drill for reaching an identified subsurface resource. During the seismic acquisition campaign, one or more seismic sources are travelling around the seismic nodes for generating the seismic waves that are recorded by the seismic nodes and used for generating the image of the subsurface.

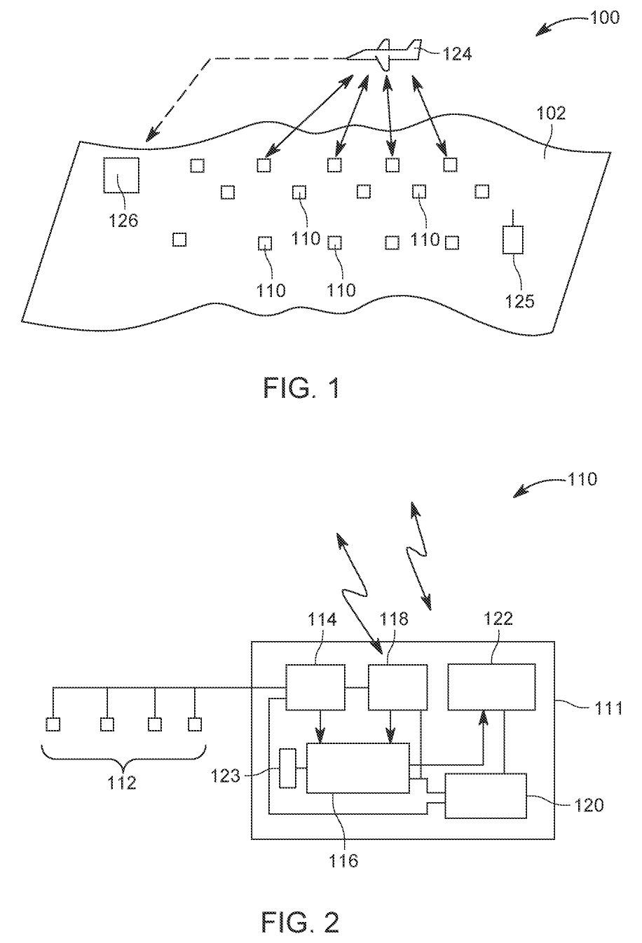

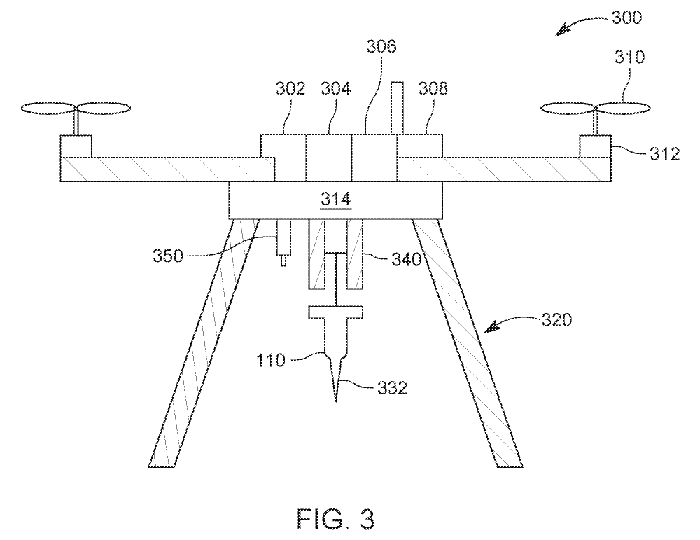

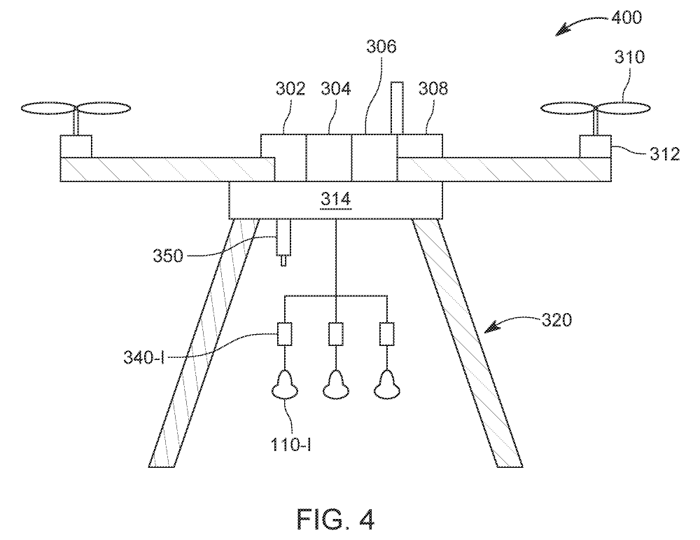

In the following embodiments, the deployment of the seismic nodes with drones, and for a land survey, is investigated. Note that in these embodiments, as illustrated in FIG. 3, a drone 300 may include a processor 302, a memory 304 for storing the waypoints, a transceiver 306 for communicating with a base (e.g., element 126 in FIG. 1), a GPS module 308 for determining its position, propellers 310, corresponding motors 312, a power source 314 for powering all these elements, and a support system 320, for allowing the drone to land. A seismic node (e.g., a geophone) 110 may be provided with a spike 332 for entering the soil when deployed, so that a good contact with the soil is achieved. A launching mechanism 340 is attached to a frame of the drone and is configured to launch the seismic node 110 when instructed by the processor 302. The launching mechanism 340 may be a passive module, i.e., a mechanism that only releases the seismic node 110 and due to the gravity, the seismic node 110 gets embedded into the soil. In one application, the launching mechanism 340 is an active module, i.e., a mechanism that provides an impulse or force to accelerate the seismic node 110 to enter the soil.

While the drone 300 is shown having the capability of launching a single seismic node 110, FIG. 4 illustrates a similar drone 400 that has the capability of carrying and launching plural seismic nodes 110-I, each having a corresponding launching mechanism 340-I. For this case, each launching mechanism 340-I may be independently controlled by the processor 302. The drones 300/400 may further include one or more imaging devices (e.g., a camera) 350 for monitoring the deployment of the seismic nodes 110.

Traditionally, the operator of the drones calculates, for each drone (if multiple drones are used), a path of the drone, how many seismic nodes the drone should carry, and at what locations the drone should stop to deploy a corresponding seismic node. Given that a seismic acquisition system may include thousands of seismic nodes and tens if not hundreds of drones, and all the seismic nodes need to be deployed in the shortest amount of time possible, to keep the cost of the seismic survey low, it becomes a real challenge for the operator to determine the waypoints for each drone in the most efficient way.

In an effort to standardize the details associated with a seismic survey acquisition, the Society of Exploration Geophysicists (SEG) has implemented a common standard for the transfer of positioning and geophysical support data from 3D field crews (that perform the seismic acquisition campaign and acquire the seismic data) to seismic processing centers (that process the acquired seismic data for generating the image of the subsurface). This standard is called Shell Processing Support format, or SPS. The SPS standard is used by most of the companies that acquire seismic data. The SPS standard establishes various files, e.g., receiver file (also called the “R file” or receiver processing support (RPS) file), source file (S file), and cross-reference file (X file) that include information about the receivers (seismic nodes), the seismic sources, and the relationships between these elements. For example, coordinates and elevations of geophysical lines may be determined by interpolation between observed break points in a line. The point files contain coordinates and elevations of all geophysical points (observed and interpolated) and of all permanent markers. The shotpoint and relational files are to be sorted chronologically, and the receiver file is to be sorted in ascending sequence of line, point and point index numbers.

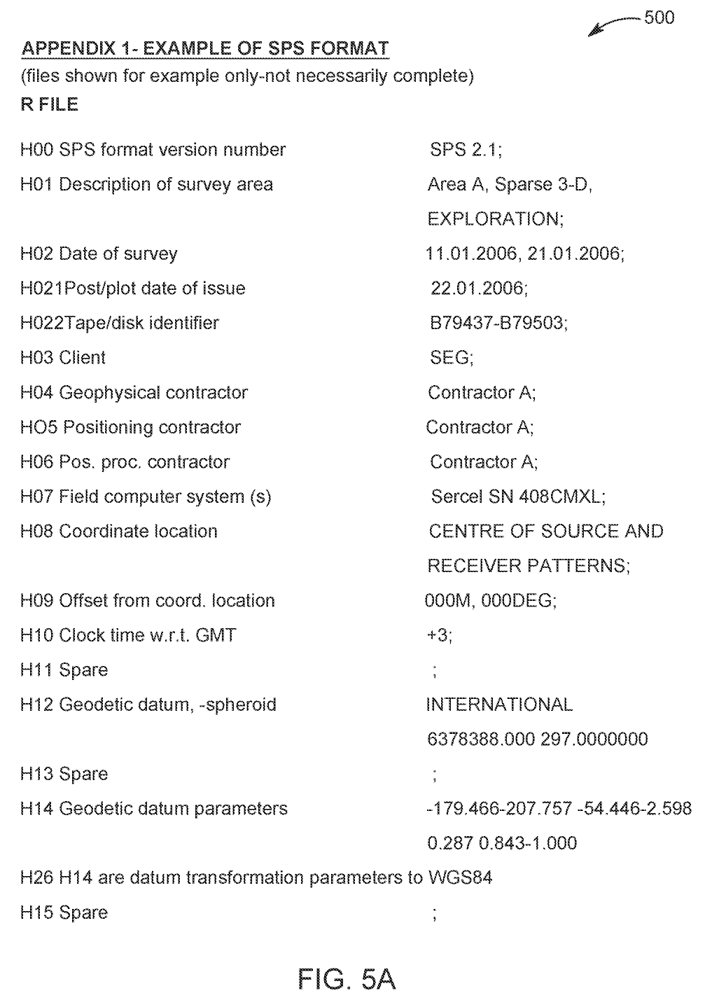

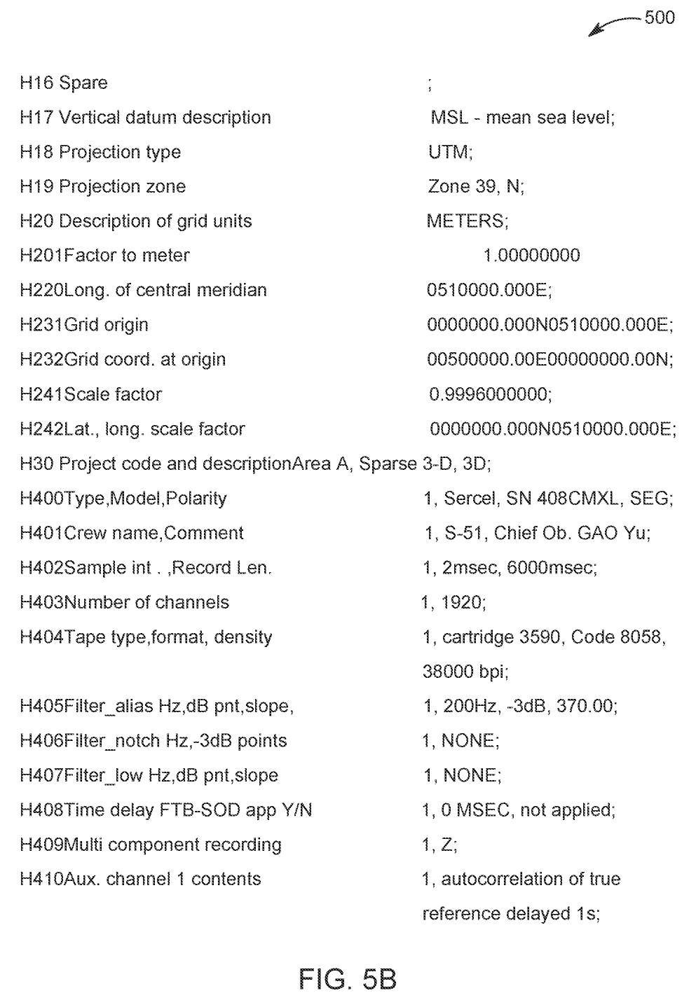

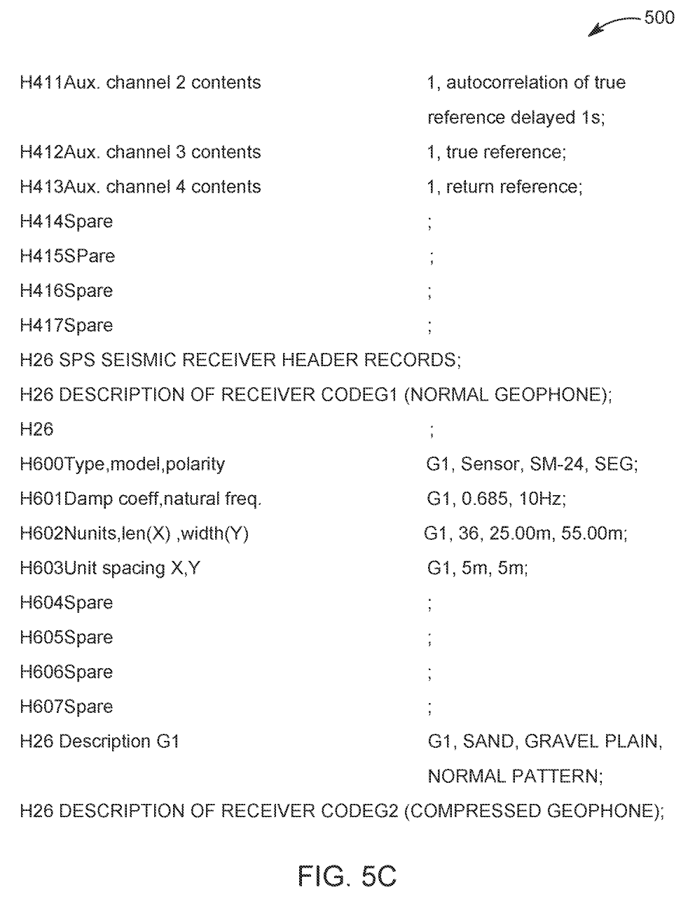

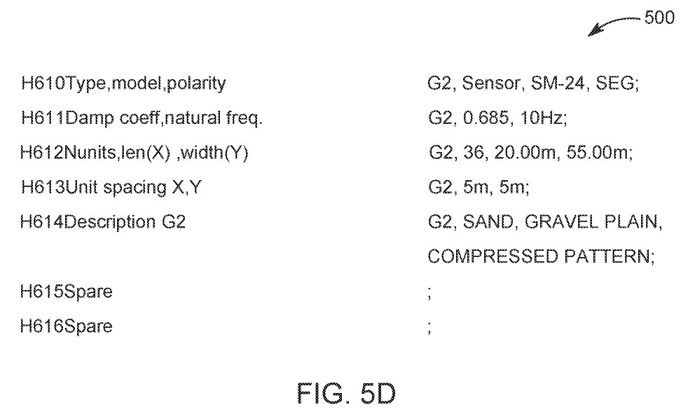

The format of an R file 500 is partially illustrated in FIGS. 5A-5D. It is noted that the full format of the R file includes additional fields. However, as they are not relevant to the embodiments discussed in this document, those fields are omitted. The fields shown in FIGS. 5A-5D describe, among others, the survey area (field H01), date of survey (H02), coordinate location (H08), geodetic datum parameters (H14), grid origin (H231), number of channels (H403), type of sensor (H600), unit spacing (H603), soil description (H26), etc. These fields also refer to the type of sensor, their density, their physical location within the survey area, etc. Thus, the R file 500 for a given seismic survey provides all the information regarding the location of the receivers (sensors) in the survey area, their elevation, and the type of the receivers (which implicitly provides information about the weight of each receiver).

According to an embodiment, a novel method and corresponding system are configured to use the RPS file 500 to determine a comma-separated values (CVS) file (e.g., CVS Waypoint, which is readable by a Litchi platform, see flylitch.com site, but other platforms may be used) for each drone used to deploy seismic nodes. The CVS file is loaded into a corresponding drone and drives the drone to the necessary locations where the seismic nodes need to be deployed. The CVS file may include not only the stop (deploying) locations for the seismic nodes, but also the drone speed for each segment of the route, the drone altitude at various points along the route, the drone hoovering time before deploying a corresponding seismic node at a certain location, etc.

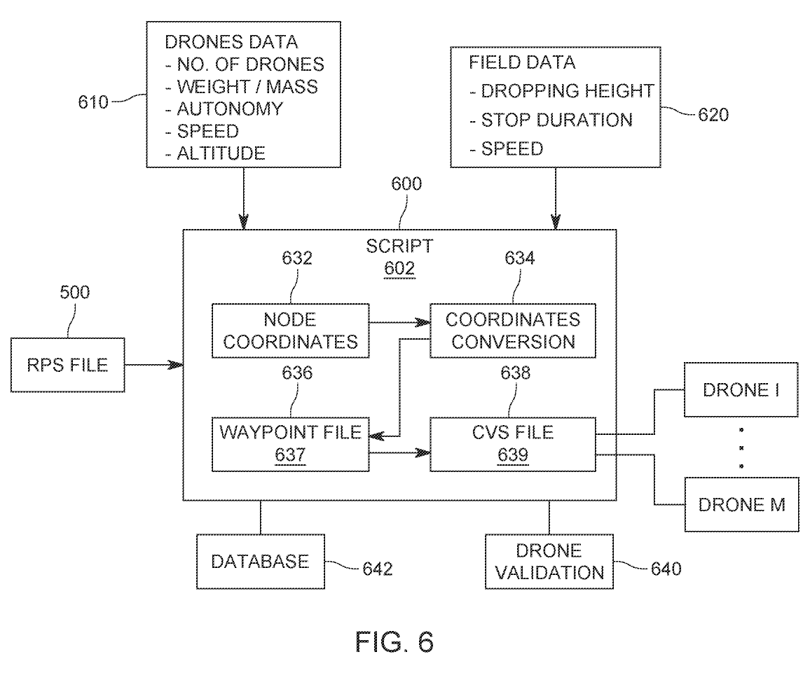

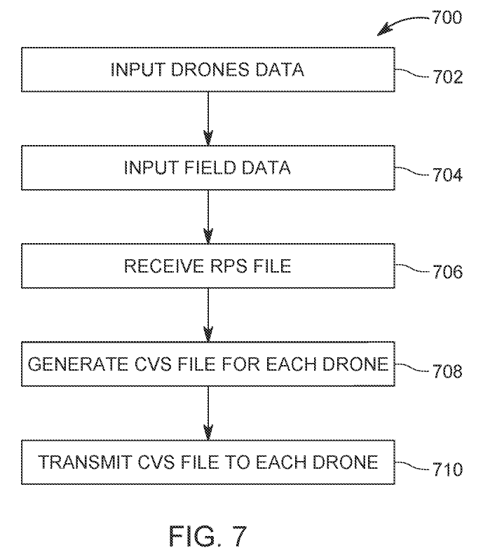

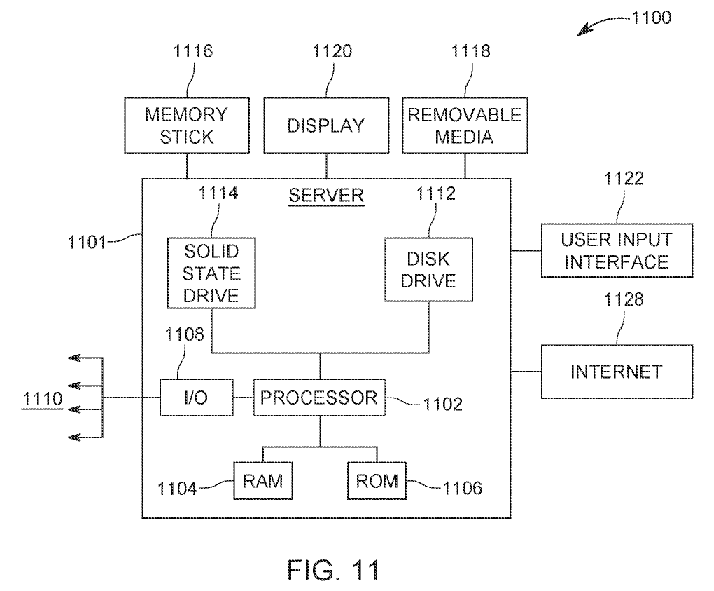

FIG. 6 schematically illustrates a platform 600 that support a process of generating the CVS file for each drone and FIG. 7 is a flow chart of such process. According to the method 700 illustrated in FIG. 7, the operator of the drones inputs in step 702 drones data 610 to the platform 600. In one embodiment, the platform 600 may be a computing system, which is discussed later with regard to FIG. 11. The drones data may include a number M of drones used to deploy the seismic nodes, and one or more features of each drone. The one or more features may include a weight or mass that each drone can carry (e.g., payload), an autonomy of each drone (e.g., a maximum distance that can be travelled by the drone before a need to recharge its battery), a maximum speed, a maximum altitude, or any other characteristic of the drone.

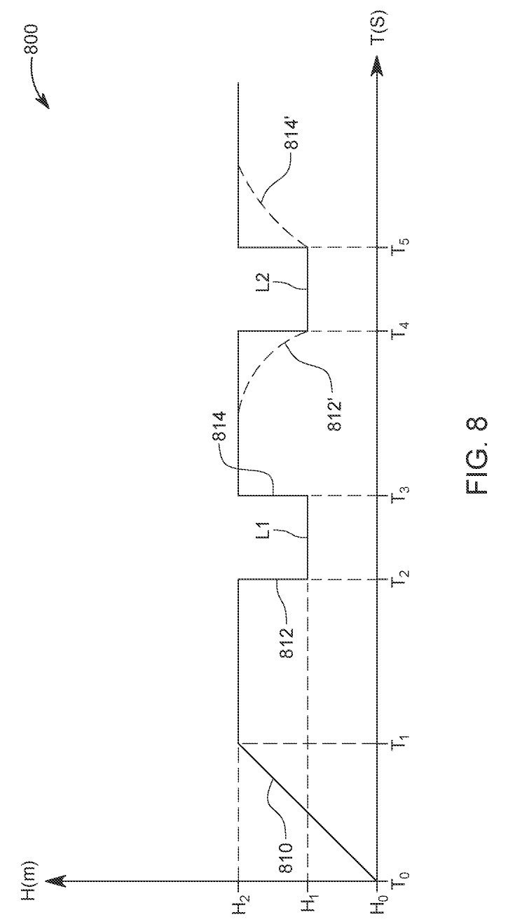

The operator may further input 704 field data 620 associated with the seismic survey. The field data 620 may include a dropping height H1, as illustrated in FIG. 8. This figure illustrates a route 800 followed by the drone 300 or 400, from a base located at a height of H0 m (usually H 0= 0 m, but the base may be elevated relative to the ground), to a travelling height H2. The drone leaves the base at time T0 and reaches the traveling height H2 at a first time T1. When arriving at a desired location L1, the drone stops, and changes its height from the traveling height H2 to the dropping height H1. The drone is stationary between times T2 and T3. The time interval T3 - T2 may be in the order of seconds so that a pendulum motion that may be experienced by the attached seismic node(s) 110-I dissipates. After this time period, it is assumed that the seismic node 110-I is still, and thus, the processor of the drone instructs the corresponding launching mechanism 340-I to release or to shoot the seismic node 110-I toward the ground. Note that if the drone does not stop for the time interval T3 -T2, because of the pendulum motion experienced by the seismic node 110-I, the launching direction of the node may depart from the gravity, and the seismic node may land at a position different from the intended landing position L1. Thus, the value of the time interval T3-T2 is selected based on the characteristics of the launching mechanism (340-I) and also based on a cruising speed of the drone during the time interval T1 to T2. The cruising speed of the drone may be specified in the field data 620.

Once the corresponding seismic node has been launched at location L1, the drone flies back to the traveling height H2 and moves to the next landing location L2, and repeats the steps discussed above to launch the next seismic node. Thus, the field data 620 provides the dropping height H1, the travelling height H2, a traveling speed V, a stop duration T3-T2 for each dropping height. In one embodiment, the portions 810 to 814 of the trajectory of the drone may also be controlled, for example, to make them smoother or steeper (see elements 812’ and 814’ in FIG. 8). While the above description refers to a same dropping height H1 for all seismic nodes dropped by a given drone, it is possible that different dropping heights are used for different dropping locations for the same drone. The same is true for the drone cruising speed for different segments of the route 800 illustrated in FIG. 8.

The platform 600 receives in step 706 the RPS file 500 discussed above with regard to FIGS. 5A-5D. Thus, at this step, the platform 600 has all the positions and the altitudes (from the RPS file 500) of the seismic nodes 110-I that need to be deployed in the seismic area of the seismic survey. Further, at this step, the platform 600 has the weights of all the nodes (read from the RPS file 500). Using the RPS file 500 to achieve all this information saves a considerable amount of time for the route planning process.

Next, the platform 600 generates in step 708 a CVS file (which includes waypoints forming the drone route) for each drone and transmits in step 710 the generated CVS file to a corresponding drone. The generation step 708 includes a sub-step 632 of extracting the seismic node coordinates (for each node) from the RPS file 500, a sub-step 634 of transforming the universal transverse Mercator (UTM) coordinates, which are typically stored in the RPS file 500, to longitude and latitude coordinates, which are typically used by the drones, and a sub-step 636 for generating a waypoint file for each drone. The sub-step 636 may use an existing model, for example, travelling salesman problem, or vehicle routing problem, or dynamic dispatch waves problem, for determining the best route for a given drone for delivering a certain number of seismic nodes to a given area of the seismic survey area. These models require the coordinates for the delivery points, the starting point of the drone, the load capacity of each drone, the battery limitation of each drone, the no-fly zones in the survey area, and/or wind conditions. If the same drone is used multiple times to deliver the seismic nodes, then it is possible to use K-means clustering to divide the locations of the seismic area into groups and then calculate the routes.

The waypoint file 637 indicates all the locations L1, L2 for a given drone for distributing its payload of seismic nodes. Then, in sub-step 638, the platform 600 transforms the waypoint file 637 into a CVS file 639. If the seismic survey uses M drones (where M is a positive integer), sub-step 638 generates M CVS files, and each file is uploaded to its corresponding drone. One file may include a single route or multiple routes. If the file includes multiple routes, this means that the drone will perform the first route, comes back to the base to recharge its battery and take another load of seismic nodes, then performs the second route, returns to the base to recharge its battery and take another load of seismic nodes, and so on until all the routes in the file 639 are fulfilled.

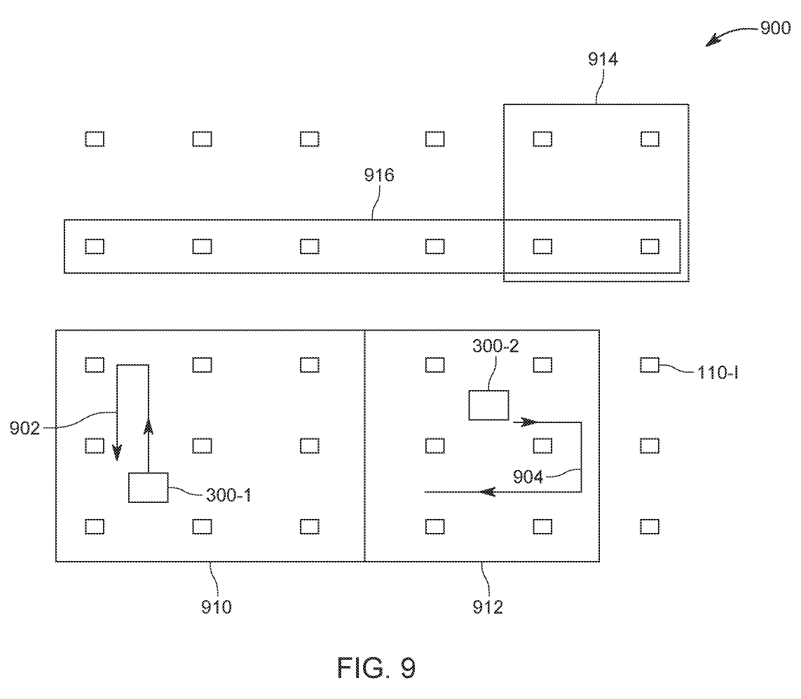

The platform 600 may run an existing drone software 640, for example, Litchi, which allows the operator of the drones to display the drone flying plans for validation and/or modification. Other software platforms may be run for validating the drone trajectories. The operator ensures that all sensor node locations are covered by the M drones, and no two drones have trajectories that intersect at the same instant. Also, the platform may check that no drone carries a load larger than its assigned load. To avoid drone collision, drones 300-1 and 300-2 that operate along adjacent regions 910 and 912 in a survey area 900 as illustrated in FIG. 9, are configured to travel along routes 902/904 at different travelling heights H2. In another embodiment, the drones are configured to cover non-adjacent regions 910 and 914 when operating at the same time. In yet another embodiment, each drone is configured to follow a certain line of seismic nodes 110-I, for example, belonging to a block 916.

Returning to FIG. 6, the platform 600 may use a script 602 for performing the sub-steps 632 to 636 and validating software 640 for the sub-step 638. The script 602 may be run in Python or any other language. The script 602 may be configured to have access to an external database 642. This database may be related to a Google map or Google geographic data for better handling of the various coordinates of the seismic nodes and/or the waypoints of the drones.

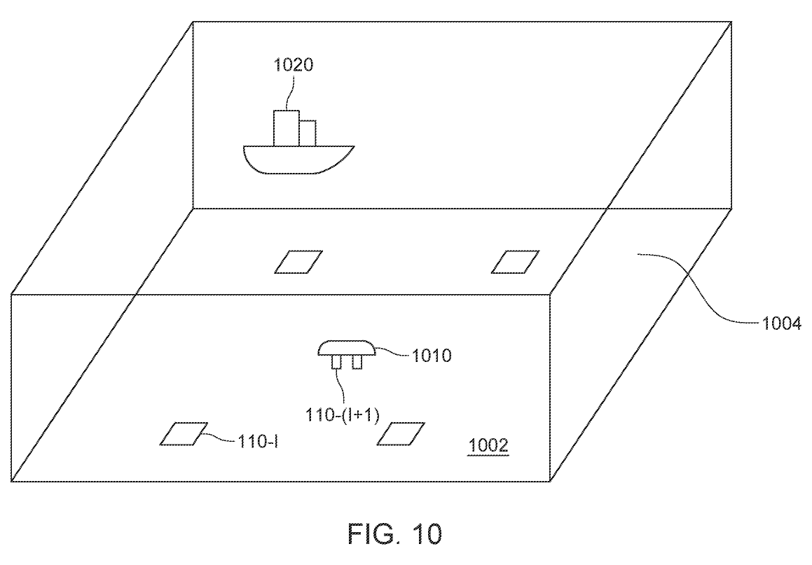

While the above embodiments were discussed with regard to placing seismic nodes on a land survey area, these embodiments may also be implemented for ocean bottom nodes 110-I, which are distributed on the ocean bottom 1002, as illustrated in FIG. 10. This figure shows an autonomous underwater vehicle (AUV) 1010 carrying plural seismic nodes 110-(I+1) underwater and distributing them on the ocean bottom 1002. A mother vessel 1020 may be the base for this scenario, and the AUV 1010 returns to this vessel for refueling and reloading with seismic nodes. The AUV 1010 performs the drone functions but in the volume of water 1004. For the underwater seismic acquisition, the same RPS file 500 is used for generating the route (trajectory) of the AUV.

The above-discussed procedures and methods may be implemented in a computing device as illustrated in FIG. 11. Hardware, firmware, software or a combination thereof may be used to perform the various steps and operations described herein. The computing device 1100 (which supports platform 600) is suitable for performing the activities described in the above embodiments and may include a server 1101. Such a server 1101 may include a central processor (CPU) 1102 coupled to a random access memory (RAM) 1104 and to a read-only memory (ROM) 1106. ROM 1106 may also be other types of storage media to store programs, such as programmable ROM (PROM), erasable PROM (EPROM), etc. Processor 1102 may communicate with other internal and external components through input/output (I/O) circuitry 1108 and bus 1110 to provide control signals and the like. Processor 1102 carries out a variety of functions as are known in the art, as dictated by software and/or firmware instructions.

Server 1101 may also include one or more data storage devices, including hard drives 1112, solid-state drives 1114 and other hardware capable of reading and/or storing information, such as DVD, etc. In one embodiment, software for carrying out the above-discussed steps may be stored and distributed on a memory stick 1116, a solid state storage device 1118 or other form of media capable of portably storing information. These storage media may be inserted into, and read by, devices such as solid state drive 1114, disk drive 1112, etc. Server 1101 may be coupled to a display 1120, which may be any type of known display or presentation screen, such as LCD, plasma display, cathode ray tube (CRT), etc. A user input interface 1122 is provided, including one or more user interface mechanisms such as a mouse, keyboard, microphone, touchpad, touch screen, voice-recognition system, etc.

Server 1101 may be coupled to other devices, such as land seismic sensors, drones, etc. The server may be part of a larger network configuration as in a global area network (GAN) such as the Internet 1128, which allows ultimate connection to various landline and/or mobile computing devices.

As described above, the apparatus 1100 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 1102 may be configured to execute instructions stored in the memory device 1104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The disclosed embodiments provide a method for generating trajectories for one or more drones for deploying multiple seismic nodes over a given survey area. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details. In particular, deployment of ocean bottom nodes (OBN) on the seabed, by submarine drones, may use similar methods and devices for defining the routes.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The following references were cited in this document:

International Patent Application WO 2023/285849.

U.S. Patent Application Publication US 2023/393293.

Levell and Campman, “Drones for Deploying Seismic Nodes: For those Hard to Reach Places,” EAGE Annual Conference, March 2018, DOI: 10.3997/2214-4609.201801401.

Stephenson and Strong, “Drones as a support tool for seismic acquisition,” ASEG Extended Abstracts, 2019, 1-4, DOI 10.1080/22020586.2019.12072919.

International Patent Application WO 2014/047096.

International Patent Application WO 2014/166937.

International Patent Application WO 2014/046803.

U.S. Patent No. 11,603,204.

What is claimed is:

1. A method for generating a route for a drone for seismic node deployment, the method comprising:
receiving drone data;
receiving field data with regard to one or more drone features;
receiving a receiver processing support (RPS) file that conforms with a shell processing support format for 3D surveys as defined by society of exploration geophysicists (SEG);
generating a comma-values separated (CVS) file including waypoints making up the route of the drone, based on the RPS file, the drone data, and the field data; and
transmitting the CVS file to the drone for the seismic node deployment.

2. The method of claim 1, wherein the RPS file includes universal transverse Mercator (UTM) coordinates for each location of multiple seismic nodes to be deployed for a seismic acquisition survey.

3. The method of claim 2, further comprising:
transforming the UTM coordinates of each seismic node into latitude and longitude coordinates.

4. The method of claim 3, further comprising:
generating a waypoint file, based on the latitude and longitude coordinates of each seismic node, a starting point of the drone, and the field data,
wherein the waypoint file includes plural locations where the drone should stop to drop a corresponding seismic node.

5. The method of claim 4, further comprising:
generating the CVS file from the waypoint file.

6. The method of claim 1, wherein the drone data includes a number of drones to be used to deploy M seismic nodes associated with a seismic survey, a mass of each node of the M seismic nodes, and a maximum distance the drone travels before recharging a battery.

7. The method of claim 1, wherein the one or more features of the field data includes at least one: a dropping height for each seismic node, a travelling height for each drone between consecutive drone locations, a stop duration for each drone at a planned deployment location of each seismic node, and a cruising speed of the drone between the consecutive drone locations.

8. The method of claim 1, further comprising:
loading the drone with multiple seismic nodes; and
launching the drone loaded with the CVS file for deploying the multiple seismic nodes at planned deployment locations.

9. The method of claim 1, further comprising:
generating additional CVS files for additional drones,
wherein each drone of the additional drones is configured to deploy a subset of all seismic nodes that are associated with a seismic survey acquisition campaign.

10. The method of claim 9, wherein the CVS file and the additional CVS files simultaneously drive the drone and the additional drones over a given survey area.

11. A computing device for generating a route for a drone for seismic node deployment, the computing device comprising:
an interface configured to:
receive drone data,
receive field data with regard to one or more drone features, and
receive a receiver processing support (RPS) file that conforms with a shell processing support format for 3D surveys as defined by society of exploration geophysicists (SEG); and
a processor connected to the interface and configured to,
generate a comma-values separated (CVS) file including waypoints making up the route of the drone, based on the RPS file, the drone data, and the field data, and
transmit the CVS file to the drone for the seismic node deployment.

12. The computing device of claim 11, wherein the RPS file includes universal transverse Mercator (UTM) coordinates for each location of multiple seismic nodes to be deployed for a seismic acquisition survey.

13. The computing device of claim 12, wherein the processor is further configured to:
transform the UTM coordinates of each seismic node into latitude and longitude coordinates.

14. The computing device of claim 13, wherein the processor is further configured to:
generate a waypoint file, based on the latitude and longitude coordinates of each seismic node, a starting point of the drone, and the field data,
wherein the waypoint file includes plural locations where the drone should stop to drop a corresponding seismic node.

15. The computing device of claim 14, wherein the processor is further configured to:
generate the CVS file from the waypoint file.

16. The computing device of claim 11, wherein the drone data includes a number of drones to be used to deploy M seismic nodes associated with a seismic survey, a mass of each node of the M seismic nodes, and a maximum distance the drone travels before recharging a battery.

17. The computing device of claim 11, wherein the one or more features of the field data includes at least one: a dropping height for each seismic node, a travelling height for each drone between consecutive drone locations, a stop duration for each drone at a planned deployment location of each seismic node, and a cruising speed of the drone between the consecutive drone locations.

18. The computing device of claim 11, wherein the processor is further configured to:
instruct a transceiver to load the drone with multiple seismic nodes; and
instruct the drone, loaded with the CVS file, to deploy the multiple seismic nodes at planned deployment locations.

19. The computing device of claim 11, wherein the processor is further configured to:
generate additional CVS files for additional drones,
wherein each drone of the additional drones is configured to deploy a subset of all seismic nodes that are associated with a seismic survey acquisition campaign.

20. The computing device of claim 19, wherein the CVS file and the additional CVS files simultaneously drive the drone and the additional drones over a given survey area.
